(19) United States
(12) Patent Application Publication
(10) Pub. No.: US 2008/0127275 A1
(43) Pub. Date: May 29, 2008

(54) METHOD AND RELATED SYSTEM CAPABLE OF NOTIFYING AND BUFFERING PREDETERMINED EVENTS IN A PROGRAM

(76) Inventors: Shih-Min Tang, Tainan County (TW); Ho-Chao HUANG, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/620,712

(22) Filed: Jan. 7, 2007

(30) Foreign Application Priority Data
Nov. 27, 2006 (TW) 095143716

(51) Int. Cl. H04N 7/025

(52) U.S. Cl. 725/56

(57) ABSTRACT

In a method capable of notifying and buffering predetermined events in a program, a first program is broadcast on a first channel. While broadcasting the first programs, it is determined whether a predetermined event occurs in a second program broadcast on a second channel. If the predetermined event occurs in the second program, related contents of the predetermined event are buffered and a notification message is displayed on the first channel.

### BACKGROUND OF THE INVENTION

1. Field of the Invention

The present invention relates to a display method and related system, and more particularly, to a display method and related system capable of notifying and buffering predetermined events in a program.

2. Description of the Prior Art

With rapid development in consumer electronic products, video entertainment products have become essential in daily life. For television sets widely available in household, only wireless television stations providing limited amounts of channels were available in the past. As technology progresses, cable televisions can offer consumers more than a hundred channels. Recently, digital televisions are gaining more and more attention due to superior display quality and more powerful functions such as setting the turn-on time, timer-recording, frame-division for viewing multiple programs simultaneously, and time-shifting. When performing time-shifting, program data is normally stored in a buffer so that a user can watch a live program in the same way as watching a video tape. In addition, the user can retrieve contents of a program that have been previously broadcast while watching the current program on a real time basis, as well as execute operations such as rewind, fast-rewind, pause or play on the retrieved contents of the program.

Generally speaking, broadcast systems such as television sets can receive and process different types of source information. Source information, including audio and video signals, can be transmitted, received and stored in different formats using various techniques. Base on the received source information, the broadcast system can display dramas, movies, musical programs or sport events on different channels. Therefore, the user can view various types of programs by switching between the channels. However, as the number of channels increases substantially, it is time- and effort-consuming for the user to search for programs of interest among numerous channels. Also, many users may not be able to watch an entire program due to time constraint, or they simply do not want to spend much time. For example, a sport enthusiast may prefer certain types of sport events. For the programs broadcast on a sport channel, European football fans may only want to watch matches of the English Premier League, the Italian Serie A, the Spanish Primera Liga, the German Bundesliga, or the UEFA Champions League. American viewers mainly watch NFL (Major Professional Football League), MLB (Major League Baseball), or NBA (National Basketball Association) games. British or Australian audience may also be interested in cricket games. If the user does not know the timetable of the sport channel, it often takes a lot of time to search or wait for the programs of interest.

In addition, due to time constraint or other reasons, some users may only want to watch important clips or exciting scenes in a sport program. For the same baseball game, viewer A may merely want to watch the game contents regarding each run, viewer B may only pay attention to the scenes when home runs are given, while viewer C may be interested in the moments when the pitcher strikes out a batter. Similar situations may also occur in non-sport programs. For example, when broadcasting the Academy Award Ceremony, a user may only want to watch the scenes when the winners of specific awards are announced, while skipping the sideshows of the host or other performers. Also, as the number of available channel increases, the user often switches between different channels for watching multiple programs of interest during the same period of time. For example, while watching national news, a user may often switch to a local channel in order to watch local weather reports. When the user swicthes between different channels, there is no guarantee that important clips or exciting scenes in a program will not be missed.

In U.S. Pat. No. 6,694,352 entitled “Method and systems for notifying clients concerning live electronic presentations”, US Patent application No 20030018967 entitled “Method and apparatus for enhancing television programs with event notifications”, US Patent application No 20050086688 entitled “Methods and systems for managing viewing of multiple live electronic presentations”, and US Patent application No 20040111747 entitled “Methods and systems for notifying clients concerning electronic presentations”, methods for notifying predetermined events in a program are disclosed. If a predetermined event occurs in a second program broadcast on a second channel when a user is watching a first program broadcast on a first channel, the prior art method sends a notifying message so that the user can switch to the second channel. However, the program contents related to the predetermined event may be very short, and may already come to an end before the user switches to the second channel. Also, if the first program reaches a climax when the notifying message arrives, the user may not want to switch to the second channel. Therefore, the user may miss the program contents related to the predetermined event in the second program.

### SUMMARY OF THE INVENTION

The present invention provides a method capable of notifying and buffering predetermined events in a program comprising broadcasting a first program on a first channel; determining whether a first predetermined event occurs in a second program broadcast on a second channel when broadcasting the first program; and immediately buffering contents related to the first predetermined event in the second program and displaying a notification message on the first channel when the first predetermined event occurs in the second program.

The present invention also provides a multi-media audio/video system capable of notifying and buffering predetermined events in a program comprising: a first channel for receiving data corresponding to a first program; a second channel for receiving data corresponding to a second program; a first judging means for determining whether a predetermined event occurs in the second program when broadcasting the first program; a buffering means for buffering contents related to the predetermined event when the predetermined event occurs in the second program; and a notifying means for displaying a notification message on the first channel when the predetermined event occurs in the second program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method capable of notifying and buffering predetermined events in a program according to a first embodiment of the present invention.

FIG. 2 is a flowchart illustrating a method capable of notifying and buffering predetermined events in a program according to a second embodiment of the present invention.

FIG. 3 is a flowchart illustrating a method capable of notifying and buffering predetermined events in a program according to a third embodiment of the present invention.

FIG. 4 is a flowchart illustrating a method capable of notifying and buffering predetermined events in a program according to a fourth embodiment of the present invention.

FIG. 5 is a flowchart illustrating a method capable of notifying and buffering predetermined events in a program according to a fifth embodiment of the present invention.

FIG. 6 is a flowchart illustrating a method capable of notifying and buffering predetermined events in a program according to a sixth embodiment of the present invention.

FIG. 7 is a flowchart illustrating a method capable of notifying and buffering predetermined events in a program according to a seventh embodiment of the present invention.

FIG. 8 is a flowchart illustrating a method capable of notifying and buffering predetermined events in a program according to an eight embodiment of the present invention.

### DETAILED DESCRIPTION

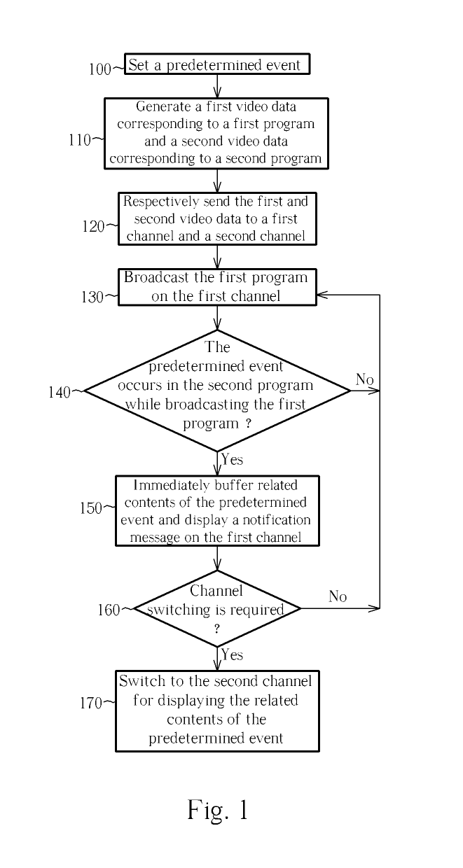

Reference is made to FIG. 1 for a flowchart illustrating a method capable of notifying and buffering predetermined events in a program according to a first embodiment of the present invention. The flowchart in FIG. 1 includes the following steps:

Step 100: set a predetermined event.

Step 110: receive and process source information for generating a first video data corresponding to a first program and a second video data corresponding to a second program.

Step 120: respectively send the first and second video data to a first channel and a second channel.

Step 130: broadcast the first program on the first channel.

Step 140: analyze the second video data for determining whether the predetermined event occurs in the second program while broadcasting the first program; if the predetermined event occurs in the second program, execute step 150; if the predetermined event does not occur in the second program, execute step 130.

Step 150: immediately buffer related contents of the predetermined event in the second program and display a notification message on the first channel.

Step 160: determine whether channel switching is required; if channel switching is required, execute step 170; if channel switching is not required, execute step 130.

Step 170: switch to the second channel for displaying the related contents of the predetermined event.

In the first embodiment of the present invention, a predetermined event is set in step 100 based on user preferences, program types or channel types. Therefore, the predetermined event set based on a certain type of program corresponds to what the user considers as “important clips” or “exciting scenes” in the program. For example, the predetermined events set for baseball games may include events such as “Homerun”, “Run” or “Strikeout”. The predetermined events set for award ceremonies may include events such as “Best Director Award”, “Best Movie Award” or “Best Actor/Actress Award”. The predetermined events set for news programs may include events such as “National News Report”, “Local News Report” or “Weather Report”. The predetermined events set for sport channels may include events such as “Baseball Game”, “Football Game” or “Basketball Game”.

Next, the source information including video data corresponding to a plurality of programs is received and processed in step 110. After executing step 110, the broadcast system respectively sends the video data related to different programs to corresponding channels. In the first embodiment of the present invention, the source information includes a first video data corresponding to the first program and a second video data corresponding to the second program. The broadcast system respectively sends the first and second video data to the corresponding first and second channels.

If the first program is the main viewing program of the user, the first program is broadcast on the first channel in step 130. Meanwhile, the user also wants to watch important clips or exciting scenes of the second program while watching the first program. Therefore, while broadcasting the first program, the broadcast system analyzes the second video data corresponding to the second program for determining whether the predetermined event occurs in the second program. For example, if the second program is a live baseball game and the predetermined event is “Run”, the present invention may determine whether the score of the baseball game changes based on the numbers normally displayed on a scoreboard of the baseball game. Also, the present invention may determine whether the predetermined event occurs based on volume and keywords. For example, assuming the second program is a live baseball game and the predetermined event is “Homerun”. When a batter hits a homerun in a baseball game, it is usually accompanied with audience applauses or passionate comments from the commentators. Accordingly, the present invention can detect keywords such as “homerun” or “homer”, and determines whether the volume of the detected keyword is higher than a predetermined value. If the volume of the keyword corresponding to the predetermined event is higher than the predetermined value, it can be determined that the predetermined event occurs in the program.

If it is determined that the predetermined event occurs in the second program after analyzing the second video data, the present invention immediately buffers related contents of the predetermined event in the second program and displays a notification message on the first channel. If it is determined that the predetermined event does not occur in the second program, the present invention execute steps 130 and 140 again until the predetermined event occurs in the second program. In step 150, the present invention may display the notification message on the first channel as a picture-in-picture (PIP) message, a picture-on-picture (POP) message, an on-screen display (OSD) message, an audio message, or other types of messages. The user can thus be informed that important clips or exciting scenes occur in the second program when the notification message is displayed on the first channel.

After observing the notification message, the user may continue to watch the first program, or switches to the second channel for watching the important clips or exciting scenes occurring in the second program. If the broadcast system receives a user command for switching channel, it is determined in step 160 that channel switching is required, and the broadcast system switches to the second channel in step 170. Thus, the user may watch the important clips or exciting scenes corresponding to the predetermined event in the second program. In the first embodiment of the present invention, when the predetermined event occurs in the second program, the related contents of the predetermined event in the second program is also immediately buffered in addition to displaying the notification message. After switching to the second channel, the user can immediately watch the second program on a real-time basis, as well as time-shifting to the start point of the predetermined event of the second program. As a result, during the process of displaying the notification message and switching channels, the user will not miss the program contents when the important clips or exciting scenes first occur.

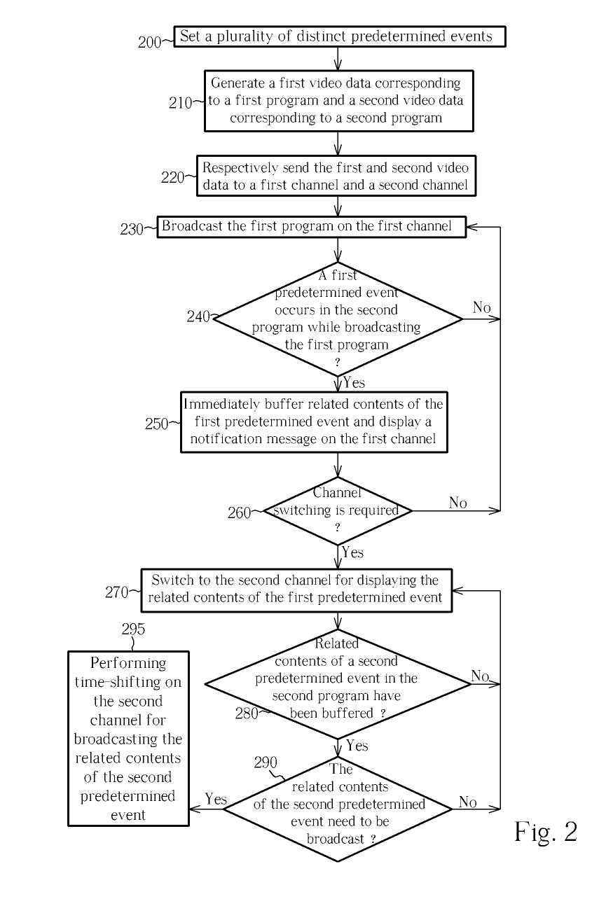

Reference is made to FIG. 2 for a flowchart illustrating a method capable of notifying and buffering predetermined events in a program according to a second embodiment of the present invention. The flowchart in FIG. 2 includes the following steps:

Step 200: set a plurality of distinct predetermined events.

Step 210: receive and process source information for generating a first video data corresponding to a first program and a second video data corresponding to a second program.

Step 220: respectively send the first and second video data to a first channel and a second channel.

Step 230: broadcast the first program on the first channel.

Step 240: analyze the second video data for determining whether a first predetermined event among the plurality of distinct predetermined events occurs in the second program while broadcasting the first program; if the first predetermined event occurs in the second program, execute step 250; if the first predetermined event does not take place in the second program, execute step 230.

Step 250: immediately buffer related contents of the first predetermined event in the second program and display a notification message on the first channel.

Step 260: determine whether channel switching is required; if channel switching is required, execute step 270; if channel switching is not required, execute step 230.

Step 270: switch to the second channel for displaying the related contents of the first predetermined event.

Step 280: determine whether related contents of a second predetermined event among the plurality of distinct predetermined events in the second program have been buffered; if the related contents of the second predetermined event have been buffered, execute step 290; if the related contents of the second predetermined event have not been buffered, execute step 270.

Step 290: determine whether the related contents of the second predetermined event need to be broadcast; if the related contents of the second predetermined event need to be broadcast, execute step 295; if the related contents of the second predetermined event do not need to be broadcast, execute step 270.

Step 295: performing time-shifting on the second channel for broadcasting the related contents of the second predetermined event in the second program.

The second embodiment is similar to the first embodiment of the present invention. However, a predetermined event is set in step 100 according to the first embodiment of the present invention, while a plurality of distinct predetermined events are set in step 200 according to the second embodiment of the present invention. For example, the plurality of distinct predetermined events set for baseball games may simultaneously include events such as “Homerun”, “Run” and “Strikeout”. The plurality of distinct predetermined events set for award ceremonies may simultaneously include events such as “Best Director Award”, “Best Movie Award” and “Best Actor/Actress Award”. The plurality of distinct predetermined events set for news programs may simultaneously include events such as “National News Report”, “Local News Report” and “Weather Report”. The plurality of distinct predetermined events set for sport channels may simultaneously include events such as “Baseball/Basketball Game” or “Football/Cricket Game”. In step 240, the notification message may be displayed on the first channel as a PIP message, a POP message, an OSD message, an audio message, or other types of messages. Also, the notification message may include information regarding to the type of the predetermined events. For example, the notification message in the second embodiment of the present invention may inform the user by means of text or audio. Therefore, the user can be informed of the occurrence of a predetermined event, as well as that the predetermined event is the first predetermined event among the plurality of predetermined events. Based on the information, the user can thus decide when to switch to the second channel.

Also, after switching to the second channel for displaying the related contents of the first predetermined event, the second embodiment of the present invention may perform time-shifting on the second channel for returning to the start point of the first predetermined event, or broadcast the related contents of other predetermined events in the second program. It is determined in step 280 whether related contents of the second predetermined event among the plurality of predetermined events in the second program have been buffered, and it is determined in step 290 whether the related contents of the second predetermined event need to be broadcast. If the user continues to watch the first program when the second predetermined event first occurs in the second program, the second embodiment of the present invention still buffers the related contents of the second predetermined event in the second program. Afterward, when the first predetermined event occurs in the second program, the user may decide to switch to the second channel for watching the related contents of the first predetermined event in the second program. After watching the related contents of the first predetermined event in the second program, the user may again decide to watch the related contents of the second predetermined event in the second program. Under these circumstances, the second embodiment of the present invention performs time-shifting on the second channel in step 295 for broadcasting the related contents of the second predetermined event in the second program

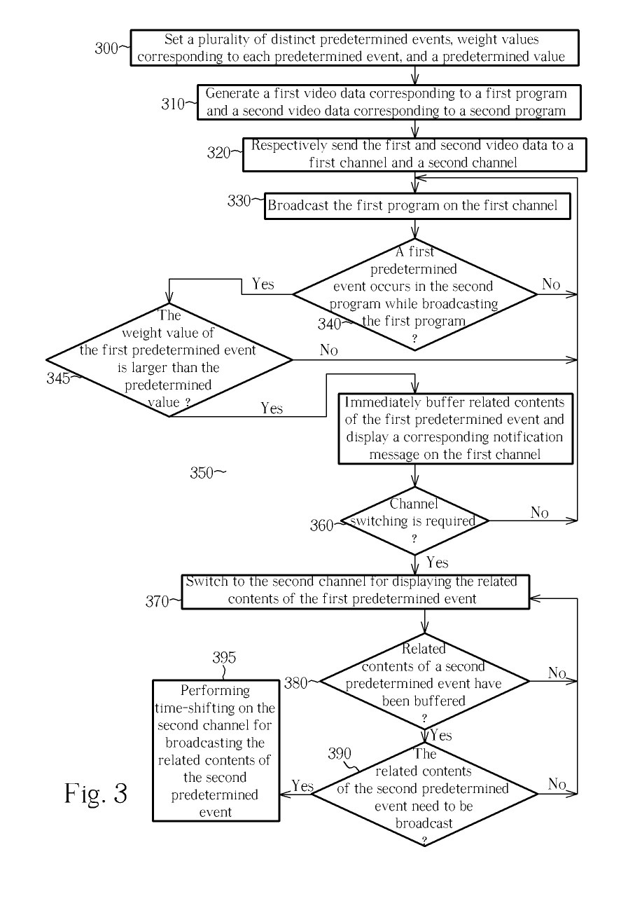

Reference is made to FIG. 3 for a flowchart illustrating a method capable of notifying and buffering predetermined events in a program according to a third embodiment of the present invention. The flowchart in FIG. 3 includes the following steps:

Step 300: set a plurality of distinct predetermined events, weight values corresponding to each predetermined event, and a predetermined value.

Step 310: receive and process source information for generating a first video data corresponding to a first program and a second video data corresponding to a second program.

Step 320: respectively send the first and second video data to a first channel and a second channel.

Step 330: broadcast the first program on the first channel.

Step 340: analyze the second video data for determining whether a first predetermined event among the plurality of distinct predetermined events occurs in the second program while broadcasting the first program; if the first predetermined event occurs in the second program, execute step 345; if the first predetermined event does not take place in the second program, execute step 330.

Step 345: determine whether the weight value of the first predetermined event is larger than the predetermined value; if the weight value of the first predetermined event is larger than the predetermined value, execute step 350; if the weight value of the first predetermined event is not larger than the predetermined value, execute step 330.

Step 350: immediately buffer related contents of the first predetermined event in the second program and display a corresponding notification message on the first channel.

Step 360: determine whether channel switching is required; if channel switching is required, execute step 370; if channel switching is not required, execute step 330.

Step 370: switch to the second channel for displaying the related contents of the first predetermined event.

Step 380: determine whether related contents of a second predetermined event among the plurality of distinct predetermined events in the second program have been buffered; if the related contents of the second predetermined event have been buffered, execute step 390; if the related contents of the second predetermined event have not been buffered, execute step 370.

Step 390: determine whether the related contents of the second predetermined event need to be broadcast; if the related contents of the second predetermined event need to be broadcast, execute step 395; if the related contents of the second predetermined event do not need to be broadcast, execute step 270.

Step 395: performing time-shifting on the second channel for broadcasting the related contents of the second predetermined event in the second program.

The third embodiment is similar to the second embodiment of the present invention. However, a plurality of distinct predetermined events are set in step 200 according to the second embodiment of the present invention, while a plurality of distinct predetermined events, weight values corresponding to each predetermined event, and a predetermined value are set in step 300 according to the third embodiment of the present invention. The weight values of the predetermined events reflect how much the user is interested in different predetermined events. For example, for the weight values corresponding to different predetermined events in a baseball game, user A may arrange the weight values in the sequence “Homerun”>“Run”>“Strikeout”, while user B may arrange the weight values in the sequence “Strikeout”>“Homerun”>“Run”.

When it is determined in step 340 that a predetermined event occurs in the second program, the third embodiment of the present invention further determines in step 345 whether the weight value of the predetermined event is larger than the predetermined value. Therefore, step 350 is executed for immediately buffering the related contents of the predetermined event in the second program and displaying the corresponding notification message on the first channel only when the weight value of the predetermined event is larger than the predetermined value. For example, if the first program is the main viewing program of the user, and the user also wants to watch important clips or exciting scenes of the second program while watching the first program. Whether the user chooses to switch channels is influenced by the contents of the first and second programs. For instance, if the first program arouses much attention, the user may be less interested in the second programs and does not want to be interrupted while watching the first program. Under these circumstances, the predetermined value set in step 300 in the third embodiment of the present invention can be used for controlling the time to display a notification message. The user can increase the predetermined value when the first program is spectacular. Therefore, only related contents of a predetermined event having a higher weight value will be immediately buffered, together with displaying a corresponding notification message on the first channel.

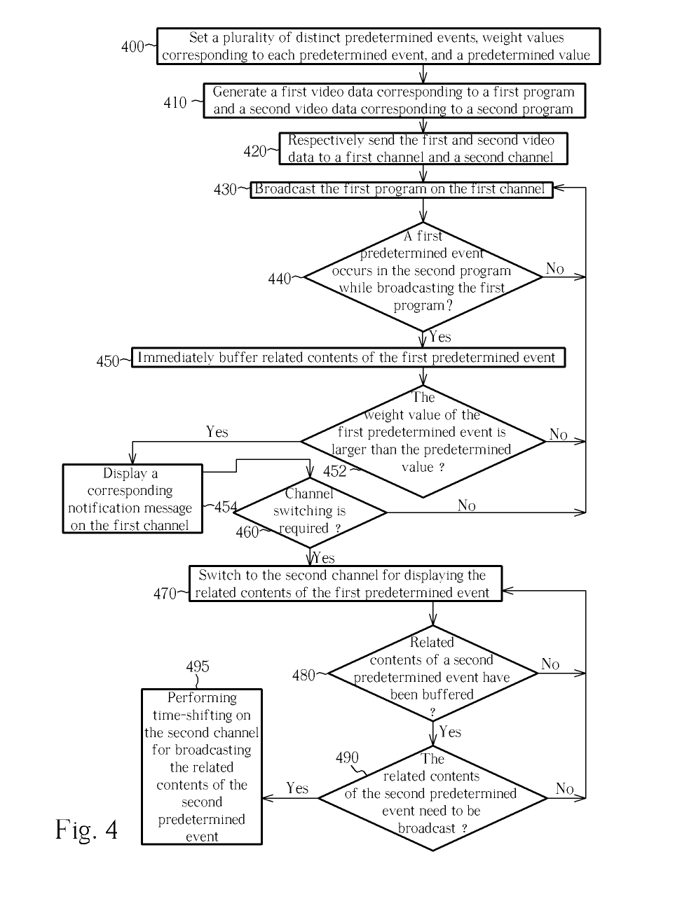

Reference is made to FIG. 4 for a flowchart illustrating a method capable of notifying and buffering predetermined events in a program according to a fourth embodiment of the present invention. The flowchart in FIG. 4 includes the following steps:

Step 400: set a plurality of distinct predetermined events, weight values corresponding to each predetermined event, and a predetermined value.

Step 410: receive and process source information for generating a first video data corresponding to a first program and a second video data corresponding to a second program.

Step 420: respectively send the first and second video data to a first channel and a second channel.

Step 430: broadcast the first program on the first channel.

Step 440: analyze the second video data for determining whether a first predetermined event among the plurality of distinct predetermined events occurs in the second program while broadcasting the first program; if the first predetermined event occurs in the second program, execute step 450; if the first predetermined event does not occur in the second program, execute step 430.

Step 450: immediately buffer related contents of the first predetermined event in the second program

Step 452: determine whether the weight value of the first predetermined event is larger than the predetermined value; if the weight value of the first predetermined event is larger than the predetermined value, execute step 454; if the weight value of the first predetermined event is not larger than the predetermined value, execute step 430.

Step 454: display a corresponding notification message on the first channel.

Step 460: determine whether channel switching is required; if channel switching is required, execute step 470; if channel switching is not required, execute step 430.

Step 470: switch to the second channel for displaying the related contents of the first predetermined event.

Step 480: determine whether related contents of a second predetermined event among the plurality of distinct predetermined events in the second program have been buffered; if the related contents of the second predetermined event have been buffered, execute step 490; if the related contents of the second predetermined event have not been buffered, execute step 470.

Step 490: determine whether the related contents of the second predetermined event need to be broadcast; if the related contents of the second predetermined event need to be broadcast, execute step 495; if the related contents of the second predetermined event do not need to be broadcast, execute step 470.

Step 495: performing time-shifting on the second channel for broadcasting the related contents of the second predetermined event in the second program.

The fourth embodiment is similar to the third embodiment of the present invention. In the third embodiment of the present invention, it is determined in step 340 whether a predetermined event occurs in the second program. When it is determine in step 345 that the weight value of the predetermined event is larger than the predetermined value, step 350 is executed for immediately buffering the related contents of the first predetermined event in the second program and displaying the corresponding notification message on the first channel. However in the fourth embodiment of the present invention, it is determined in step 440 whether a predetermined event occurs in the second program and step 450 is executed for immediately buffering the related contents of the first predetermined event in the second program. Next, if it is determine in step 452 that the weight value of the predetermined event is larger than the predetermined value, step 454 is executed for displaying the corresponding notification message on the first channel. In other words, the third embodiment of the present invention buffers the related contents of a predetermined event and displays a corresponding notification message simultaneously when the weight value of the predetermined event is larger than the predetermined value, while the fourth embodiment of the present invention buffers the related contents of each predetermined event but displays a corresponding notification message only when the weight value of the predetermined event is larger than the predetermined value.

For example, if the first program is the main viewing program of the user, and the user also wants to watch important clips or exciting scenes of the second program while watching the first program. Whether the user chooses to switch channels is influenced by the contents of the first and second programs. For instance, if the first program arouses much attention, the user may be less interested in the second programs and does not want to be interrupted while watching the first program. Under these circumstances, the predetermined value set in step 400 in the fourth embodiment of the present invention can be used for controlling the time to display a notification message. The user can increase the predetermined value when the first program is spectacular. Therefore, a corresponding notification message will be displayed on the first channel only when a predetermined event having a higher weight value occurs in the second program. Meanwhile, the related contents of each predetermined event occurring in the second program are buffered regardless of the weight value in the fourth embodiment of the present invention. As a result, time-shifting can be performed on the second channel for broadcasting the related contents of each previously buffered predetermined event.

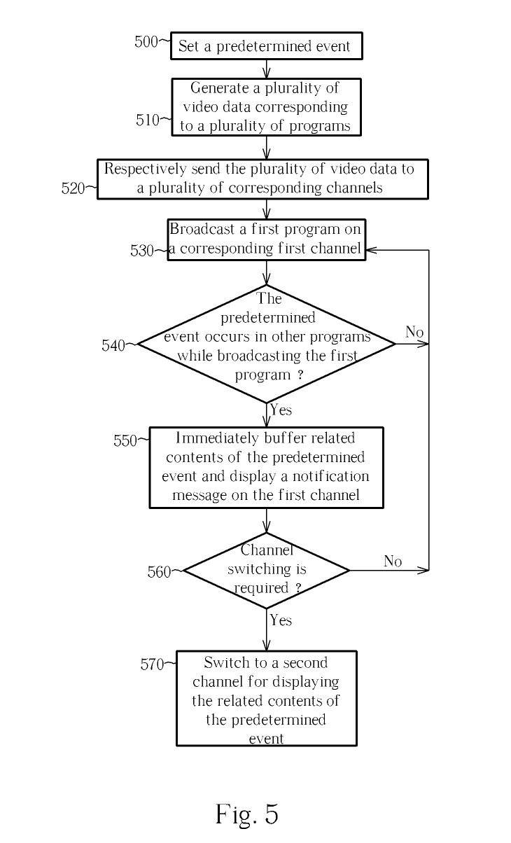

In the above noted first through fourth embodiments, when watching a program broadcast on a channel, a user can receive a notification message if a predetermined event occurs in the program broadcast on another channel. Also, when the user is watching a program broadcast on a channel, the present invention can determine whether a predetermined event occurs in a plurality of other channels and output a corresponding notification message. Reference is made to FIG. 5 for a flowchart illustrating a method capable of notifying and buffering predetermined events in a program according to a fifth embodiment of the present invention. The flowchart in FIG. 5 includes the following steps:

Step 500: set a predetermined event.

Step 510: receive and process source information for generating a plurality of video data corresponding to a plurality of programs.

Step 520: respectively send the plurality of video data to a plurality of corresponding channels.

Step 530: broadcast a first program among the plurality of programs on a corresponding first channel among the plurality of channels.

Step 540: analyze the video data corresponding to other programs among the plurality of programs for determining whether the predetermined event occurs in other programs while broadcasting the first program; if the predetermined event occurs in other programs, execute step 550; if the predetermined event does not occur in other programs, execute step 530.

Step 550: immediately buffer related contents of the predetermined event in other programs and display a notification message on the first channel.

Step 560: determine whether channel switching is required; if channel switching is required, execute step 570; if channel switching is not required, execute step 530.

Step 570: switch to a second channel for displaying the related contents of the predetermined event.

The fifth embodiment is similar to the first embodiment of the present invention. However, step 140 is executed for determining whether the predetermined event occurs in the second program according to the first embodiment of the present invention, while step 540 is executed for determining whether the predetermined event occurs in other programs among the plurality of programs according to the fifth embodiment of the present invention. In step 550, the notification message may be displayed on the first channel as a PIP message, a POP message, an OSD message, an audio message, or other types of messages. Also, the notification message may include information regarding to the type of the predetermined event and the channel showing the predetermined event. For example, the notification message in the fifth embodiment of the present invention may inform the user by means of text or audio. Therefore, the user can be informed of the occurrence of a predetermined event, as well as the type of the predetermined event and the channel showing the predetermined event. Based on the information, the user can thus decide when to switch to the corresponding channel.

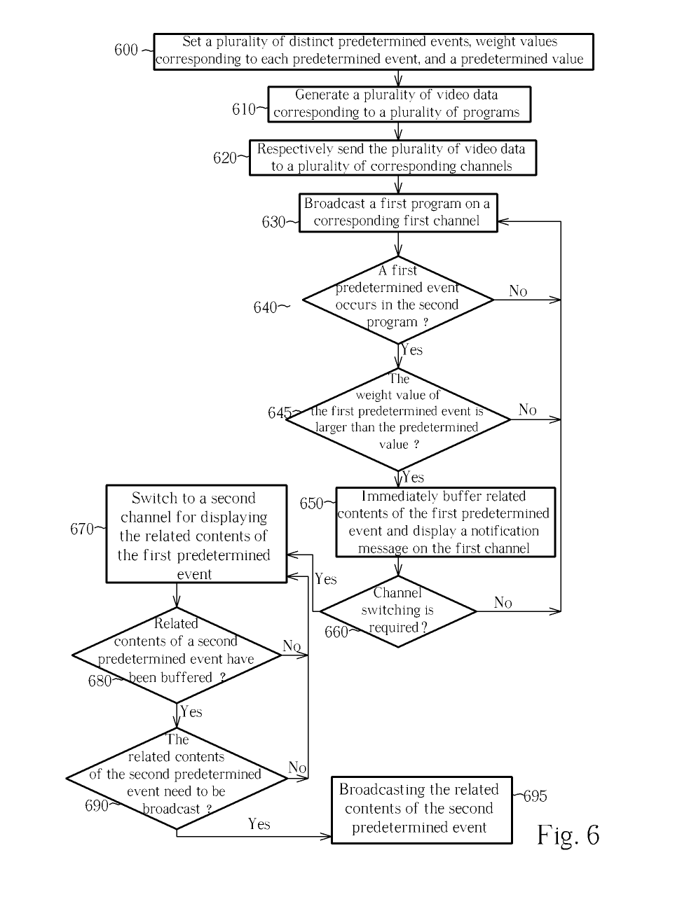

Reference is made to FIG. 6 for a flowchart illustrating a method capable of notifying and buffering predetermined events in a program according to a sixth embodiment of the present invention. The flowchart in FIG. 6 includes the following steps:

Step 600: set a plurality of distinct predetermined events, weight values corresponding to each predetermined event, and a predetermined value.

Step 610: receive and process source information for generating a plurality of video data corresponding to a plurality of programs.

Step 620: respectively send the plurality of video data to a plurality of corresponding channels.

Step 630: broadcast a first program among the plurality of programs on a corresponding first channel among the plurality of channels.

Step 640: analyze a second video data corresponding to a second program among the plurality of programs for determining whether a first predetermined event among the plurality of distinct predetermined events occurs in the second program while broadcasting the first program; if the first predetermined event occurs in the second program, execute step 640; if the first predetermined event does not occur in the second program, execute step 630.

Step 645: determine whether the weight value of the first predetermined event is larger than the predetermined value; if the weight value of the first predetermined event is larger than the predetermined value, execute step 650; if the weight value of the first predetermined event is not larger than the predetermined value, execute step 630.

Step 650: immediately buffer related contents of the first predetermined event in the second program and display a corresponding notification message on the first channel.

Step 660: determine whether channel switching is required; if channel switching is required, execute step 670; if channel switching is not required, execute step 630.

Step 670: switch to a second channel broadcasting the second program for displaying the related contents of the first predetermined event.

Step 680: determine whether related contents of a second predetermined event among the plurality of distinct predetermined events in the second program have been buffered; if the related contents of the second predetermined event have been buffered, execute step 690; if the related contents of the second predetermined event have not been buffered, execute step 670.

Step 690: determine whether the related contents of the second predetermined event need to be broadcast; if the related contents of the second predetermined event need to be broadcast, execute step 695; if the related contents of the second predetermined event do not need to be broadcast, execute step 670.

Step 695: performing time-shifting on the second channel for broadcasting the related contents of the second predetermined event in the second program.

The sixth embodiment is similar to the second embodiment of the present invention. However, step 240 is executed for determining whether the predetermined event occurs in the second program according to the second embodiment of the present invention, while step 640 is executed for determining whether the predetermined event occurs in other programs among the plurality of programs according to the sixth embodiment of the present invention. In step 650, the notification message may be displayed on the first channel as a PIP message, a POP message, an OSD message, an audio message, or other types of messages. Also, the notification message may include information regarding to the type of the predetermined event and the channel showing the predetermined event. For example, the notification message in the sixth embodiment of the present invention may inform the user by means of text or audio. Therefore, the user can be informed of the occurrence of a predetermined event, as well as the type of the predetermined event and the channel showing the predetermined event. Based on the information, the user can thus decide when to switch to the corresponding channel.

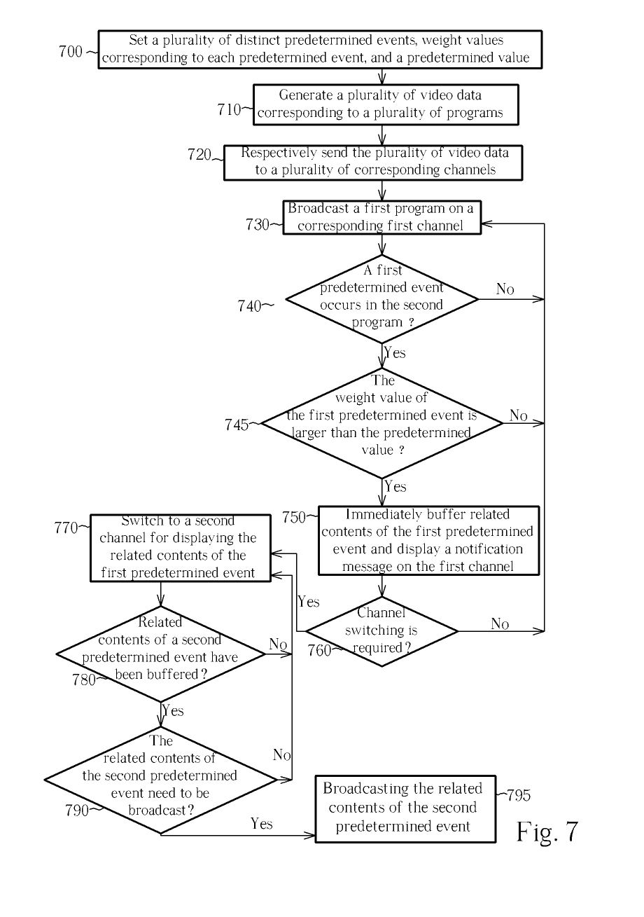

Reference is made to FIG. 7 for a flowchart illustrating a method capable of notifying and buffering predetermined events in a program according to a seventh embodiment of the present invention. The flowchart in FIG. 7 includes the following steps:

Step 700: set a plurality of distinct predetermined events, weight values corresponding to each predetermined event, and a predetermined value.

Step 710: receive and process source information for generating a plurality of video data corresponding to a plurality of programs.

Step 720: respectively send the plurality of video data to a plurality of corresponding channels.

Step 730: broadcast a first program among the plurality of programs on a corresponding first channel among the plurality of channels.

Step 740: analyze a second video data corresponding to a second program among the plurality of programs for determining whether a first predetermined event among the plurality of distinct predetermined events occurs in the second program while broadcasting the first program; if the first predetermined event occurs in the second program, execute step 745; if the first predetermined event does not occur in the second program, execute step 730.

Step 745: determine whether the weight value of the first predetermined event is larger than the predetermined value; if the weight value of the first predetermined event is larger than the predetermined value, execute step 750; if the weight value of the first predetermined event is not larger than the predetermined value, execute step 730.

Step 750: immediately buffer related contents of the first predetermined event in the second program and display a corresponding notification message on the first channel.

Step 760: determine whether channel switching is required; if channel switching is required, execute step 770; if channel switching is not required, execute step 730.

Step 770: switch to a second channel broadcasting the second program for displaying the related contents of the first predetermined event.

Step 780: determine whether related contents of a second predetermined event among the plurality of distinct predetermined events in the second program have been buffered; if the related contents of the second predetermined event have been buffered, execute step 790; if the related contents of the second predetermined event have not been buffered, execute step 770.

Step 790: determine whether the related contents of the second predetermined event need to be broadcast; if the related contents of the second predetermined event need to be broadcast, execute step 795; if the related contents of the second predetermined event do not need to be broadcast, execute step 770.

Step 795: performing time-shifting on the second channel for broadcasting the related contents of the second predetermined event in the second program.

The seventh embodiment is similar to the third embodiment of the present invention. However, step 340 is executed for determining whether the predetermined event occurs in the second program according to the third embodiment of the present invention, while step 740 is executed for determining whether the predetermined event occurs in other programs among the plurality of programs according to the seventh embodiment of the present invention. In step 750, the notification message may be displayed on the first channel as a PIP message, a POP message, an OSD message, an audio message, or other types of messages. Also, the notification message may include information regarding to the type of the predetermined event and the channel showing the predetermined event. For example, the notification message in the seventh embodiment of the present invention may inform the user by means of text or audio. Therefore, the user can be informed of the occurrence of a predetermined event, as well as the type of the predetermined event and the channel showing the predetermined event. Based on the information, the user can thus decide when to switch to the corresponding channel.

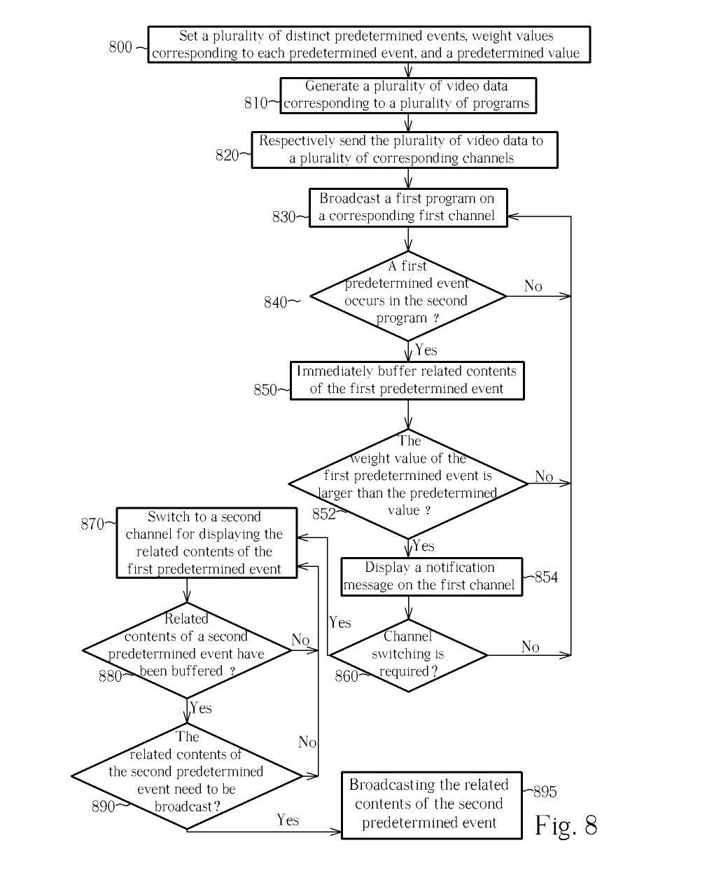

Reference is made to FIG. 8 for a flowchart illustrating a method capable of notifying and buffering predetermined events in a program according to an eight embodiment of the present invention. The flowchart in FIG. 8 includes the following steps:

Step 800: set a plurality of distinct predetermined events, weight values corresponding to each predetermined event, and a predetermined value.

Step 810: receive and process source information for generating a plurality of video data corresponding to a plurality of programs.

Step 820: respectively send the plurality of video data to a plurality of corresponding channels.

Step 830: broadcast a first program among the plurality of programs on a corresponding first channel among the plurality of channels.

Step 840: analyze a second video data corresponding to a second program among the plurality of programs for determining whether a first predetermined event among the plurality of distinct predetermined events occurs in the second program while broadcasting the first program; if the first predetermined event occurs in the second program, execute step 850; if the first predetermined event does not occur in the second program, execute step 830.

Step 850: immediately buffer related contents of the first predetermined event in the second program.

Step 845: determine whether the weight value of the first predetermined event is larger than the predetermined value; if the weight value of the first predetermined event is larger than the predetermined value, execute step 854; if the weight value of the first predetermined event is not larger than the predetermined value, execute step 830.

Step 854: display a corresponding notification message on the first channel.

Step 860: determine whether channel switching is required; if channel switching is required, execute step 870; if channel switching is not required, execute step 830.

Step 870: switch to a second channel broadcasting the second program for displaying the related contents of the first predetermined event.

Step 880: determine whether related contents of a second predetermined event among the plurality of distinct predetermined events in the second program have been buffered; if the related contents of the second predetermined event have been buffered, execute step 890; if the related contents of the second predetermined event have not been buffered, execute step 870.

Step 890: determine whether the related contents of the second predetermined event need to be broadcast; if the related contents of the second predetermined event need to be broadcast, execute step 895; if the related contents of the second predetermined event do not need to be broadcast, execute step 870.

Step 895: performing time-shifting on the second channel for broadcasting the related contents of the second predetermined event in the second program.

The eighth embodiment is similar to the fourth embodiment of the present invention. However, step 440 is executed for determining whether the predetermined event occurs in the second program according to the fourth embodiment of the present invention, while step 840 is executed for determining whether the predetermined event occurs in other programs among the plurality of programs according to the eighth embodiment of the present invention. In step 850, the notification message may be displayed on the first channel as a PIP message, a POP message, an OSD message, an audio message, or other types of messages. Also, the notification message may include information regarding to the type of the predetermined event and the channel showing the predetermined event. For example, the notification message in the eighth embodiment of the present invention may inform the user by means of text or audio. Therefore, the user can be informed of the occurrence of a predetermined event, as well as the type of the predetermined event and the channel showing the predetermined event. Based on the information, the user can thus decide when to switch to the corresponding channel.

In the present invention, if a predetermined event occurs in the programs broadcast on other channels while the user is watching a program broadcast on a certain channel, the related contents of the predetermined event is immediately buffered and a corresponding notification message is sent to the user. Therefore, after the user switches channels, the related contents of the predetermined event can be viewed on a real time basis or from the start point of the predetermined event by performing time-shifting. As a result, during the process of displaying the notification message and switching channels, the user will not miss the program contents when the predetermined event first occurs. The user can also view the program contents corresponding to other predetermined events that have previously been buffered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method capable of notifying and buffering predetermined events in a program comprising:
broadcasting a first program on a first channel;
determining whether a first predetermined event occurs in a second program broadcast on a second channel when broadcasting the first program; and
immediately buffering contents related to the first predetermined event in the second program and displaying a notification message on the first channel when the first predetermined event occurs in the second program.

2. The method of claim 1 wherein displaying the notification message on the first channel is displaying the notification message as a picture-in-picture (PIP) message, a picture-on-picture (POP) message, an on-screen display (OSD) message, or an audio message on the first channel.

3. The method of claim 1 further comprising:
determining whether channel switching is required after displaying the notification message.

4. The method of claim 3 further comprising:
switching from the first channel to the second channel for displaying the contents related to the first predetermined event in the second program when channel switching is required.

5. The method of claim 4 further comprising:
performing time-shifting on the second channel for displaying the contents related to the first predetermined event in the second program from a start point of the first predetermined event.

6. The method of claim 1 further comprising:
setting the first predetermined event.

7. The method of claim 1 further comprising:
setting a plurality of predetermined events including the first predetermined event.

8. The method of claim 7 wherein displaying the notification message on the first channel is displaying the notification message corresponding to the first predetermined event.

9. The method of claim 8 further comprising:
determining whether channel switching is required after displaying the notification message.

10. The method of claim 9 further comprising:
switching from the first channel to the second channel for displaying the contents related to the first predetermined event in the second program when channel switching is required.

11. The method of claim 10 further comprising:
determining whether contents related to a second predetermined event among the plurality of predetermined events in the second program have been buffered after displaying the contents related to the first predetermined event in the second program.

12. The method of claim 11 further comprising:
determining whether it is required to display the contents related to the second predetermined event in the second program when the contents related to the second predetermined event in the second program have been buffered.

13. The method of claim 12 further comprising:
performing time-shifting on the second channel for displaying the contents related to the second predetermined event in the second program.

14. The method of claim 7 further comprising:
determining whether the first predetermined event among the plurality of predetermined events occurs in a plurality of programs broadcast on a plurality of other channels when broadcasting the first program; and
immediately buffering the contents related to the first predetermined event in the second program broadcast on the second channel among the plurality of other channels and displaying the notification message on the first channel when the first predetermined event occurs in the second program broadcast on the second channel among the plurality of other channels.

15. The method of claim 14 wherein displaying the notification message on the first channel is displaying a notification message corresponding to the first predetermined event and the second channel.

16. The method of claim 1 further comprising setting a plurality of distinct predetermined events, weight values corresponding to each predetermined event, and a predetermined value.

17. The method of claim 16 further comprising:
determine whether a weight value corresponding to the predetermined event is larger than the predetermined value when the predetermined event occurs in the second program; and
immediately buffering contents related to the predetermined event in the second program and displaying the notification message on the first channel when the weight value corresponding to the predetermined event is larger than the predetermined value.

18. The method of claim 16 further comprising:
immediately buffering the contents related to the predetermined event in the second program when the predetermined event occurs in the second program;
determine whether a weight value corresponding to the predetermined event is larger than the predetermined value; and
displaying the notification message on the first channel when the weight value corresponding to the predetermined event is larger than the predetermined value.

19. The method of claim 1 further comprising:
determining whether the first predetermined event occurs in a plurality of programs broadcast on a plurality of other channels when broadcasting the first program; and
immediately buffering contents related to the first predetermined event in the second program and displaying the notification message on the first channel when the first predetermined event occurs in the second program broadcast on the second channel among the plurality of other channels.

20. The method of claim 19 wherein displaying the notification message on the first channel is displaying a notification message corresponding to the first predetermined event and the second channel.

21. The method of claim 1 further comprising:
receiving and processing source information for generating a first data corresponding to the first program and a second data corresponding to the second program; and
sending the first data to the first channel for broadcasting the first program.

22. The method of claim 21 further comprising:
analyzing the second data for determining whether the first predetermined event occurs in the second program.

23. The method of claim 22 wherein analyzing the second data is analyzing the second data based on image characteristics, volume or keywords for determining whether the first predetermined event occurs in the second program.

24. The method of claim 21 further comprising:
sending the second data to the second channel for broadcasting the second program.

25. A multi-media audio/video system capable of notifying and buffering predetermined events in a program comprising:
a first channel for receiving data corresponding to a first program;
a second channel for receiving data corresponding to a second program;
a first judging means for determining whether a predetermined event occurs in the second program when broadcasting the first program;
a buffering means for buffering contents related to the predetermined event when the predetermined event occurs in the second program; and
a notifying means for displaying a notification message on the first channel when the predetermined event occurs in the second program.

26. The multi-media audio/video system of claim 25 wherein the first judging means determines whether the predetermined event occurs in the second program based on image characteristics, volume or keywords.

27. The multi-media audio/video system of claim 25 further comprising:
a second judging means for determining a weight value of the predetermined event when the predetermined event occurs in the second program.

28. The multi-media audio/video system of claim 25 wherein the buffering means buffers the contents related to the predetermined event when the weight value of the predetermined event is larger than a predetermined value.

29. The multi-media audio/video system of claim 28 wherein the notifying means displays the notification message when the weight value of the predetermined event is larger than a predetermined value.
